(19) United States
(12) Patent Application Publication
(10) Pub. No.: US 2009/0160672 A1
(43) Pub. Date: Jun. 25, 2009

(54) Electric Hand Control, Especially for Electrically Adjustable Hospital and Care Beds

(75) Inventors: Henrik Winther, Sonderborg (DK); Bjame Carstensen, Augustenborg (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: LINAK A/S

(21) Appl. No.: 12/084,785

(22) PCT Filed: Nov. 10, 2006
(86) PCT No.: PCT/DK2006/000619

§ 371 Date: May 9, 2008

(30) Foreign Application Priority Data
Nov. 11, 2005 (DK) OA2005 01570

(51) Int. Cl. G05B 19/02

(52) U.S. Cl. 340/825.22

(57) ABSTRACT

An electric hand control, especially for electrically adjustable hospital and care beds comprising a number of control keys (3) located over a number of switches (2), and where a spring element (6) is mounted between the control keys (3) and the switches (2) so that an after migration of the control key is obtained, i.e. a migration after the switch is closed. The spring element can for instance be a spring leg (6) or a rubber element. The spring element allows the user to better experience the pressing of the keys and simultaneously the risk of damage as a result of rough operation of the keys is reduced.

The present invention relates to an electric hand control especially for electrically adjustable hospital and care beds as stated in the preamble of claim 1.

Typically, hand controls for hospital and care beds and the like are based on tactile switches mounted on a printed circuit in a plastic housing. Tactile switches are small brick shaped switches with an axially movable activation element on the top side which, when activated, presses a metal strip against another to create an electric conductive path. The switch is located under a key in the top side of the hand control where the key typically is a tongue like shaped part, which springs back when the key is released. A foil with graphics localizing the keys and their function is mounted over the keys. By pressing the foil the key is pressed inwards and affects the activation element on the switch. The migration on the activation element is direct and very modest, that is in the same or almost the same size as the tolerances on the subjects. As a result it is difficult to feel whether or not the switch is activated, which causes many to press the keys roughly to the detriment of these and the switches.

The object of the invention is to provide an electric hand control of the above-mentioned type with tactile switches and improved operation.

This is achieved according to the invention by constructing the hand control as stated in claim 1. The placing of a spring element between the operation keys and the switches allows the user to better experience the pressing of the keys. When pressing the operation keys once the underlying switch will immediately be activated but a continued press on the operation key will be absorbed as an after migration in the spring element and in that way not cause damage on the switches like before. There is no after migration in tactile switches after the electric connection is established in the switch—the contact is obtained in that a flexible plate is pressed against a fixed plate. When the key is pressed most people react by pressing the key hard—they are “afraid” that the switch will be deactivated and press unnecessary hard. It feels safe if a certain after migration can be felt like in the invention. Since it is not possible to feel that the switch has reached its extreme end position the user will relax his fingers and cause the activation force to be reduced a bit. The user will experience that less force is needed and will not burden his fingers as much with the result that the operation of the hand control will not be forced style. This is especially important for users with reduced finger strength like elderly and disabled people.

With recognition of the invention the spring element can be provided in different ways. In an embodiment it can be shaped as a spring leg in the key which presses on the activation element of the switch. Expediently, two-part plastic is used, where the rubber brick which is made from soft plastic is moulded integral with the key, which is made from a hard plastic material.

In another embodiment the spring element is a rubber element. In principle it can be a rubber brick or a whole rubber mat located between the operation keys and the activation element of the switch.

For the sake of completeness, we notice that capacitive switches with built-in after migration in the form of a spring leg are known from U.S. Pat. No. 4,352,144 and U.S. Pat. No. 4,090,229. In U.S. Pat. No. 4,090,229 is moreover shown a previous design in FIG. 1 with a compressible intermediate layer, which allows after migration in the switch. According to the invention the switches and the means for obtaining the after migration are separated, so that it is possible to use common tactile switches and built-in the means for obtaining the after migration in the remaining parts of the hand control. This gives a great amount of freedom as regards the choice of switches and the structure of the after migration function.

Further features of the invention will be explained more fully below in connection with an embodiment of the invention with reference to the accompanying drawing. In the drawing:

FIG. 1 shows a perspective view of the hand control

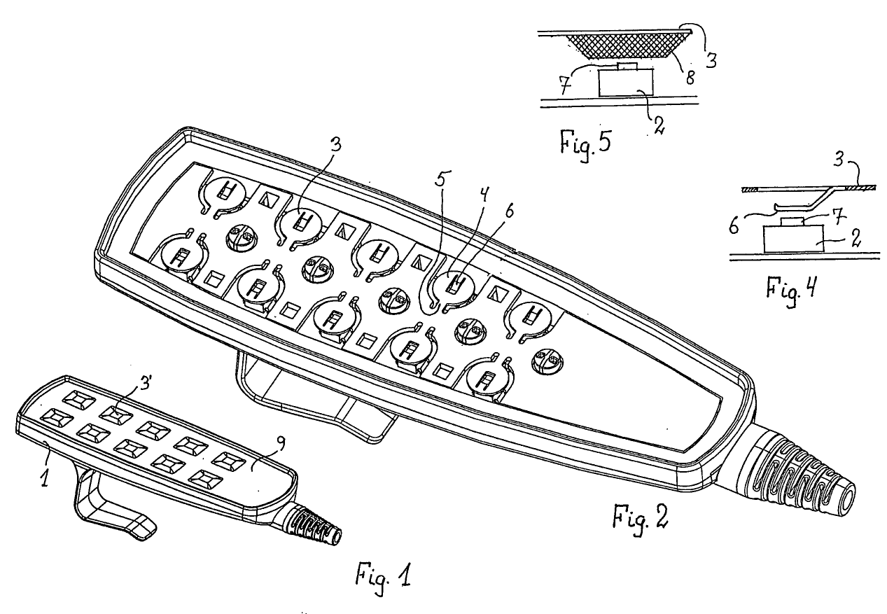

FIG. 2 shows a perspective view of the housing of the hand control without cover foil,

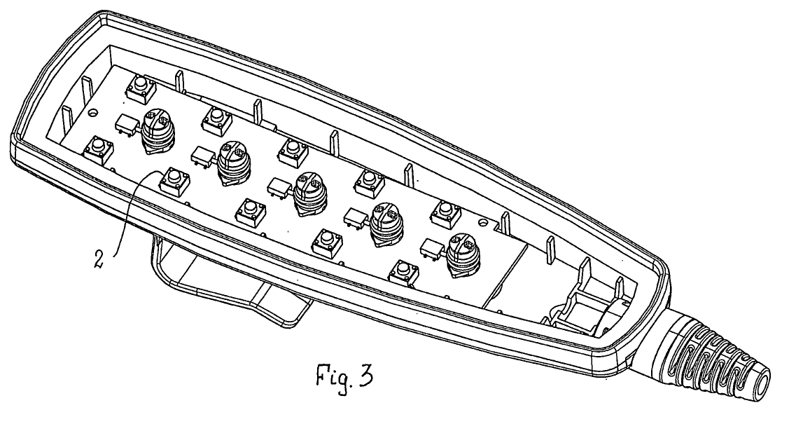

FIG. 3 shows a perspective view of the housing and printed circuit of the hand control,

FIG. 4 shows a detailed view of a key with a spring leg,

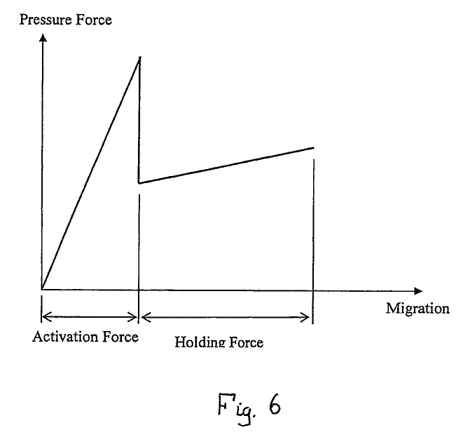

FIG. 5 shows a detailed view of a key with rubber underside, and

FIG. 6 shows en graph illustrating the pressing of the keys.

The embodiment relates to a hand control for electrically adjustable care and hospital beds with actuators for raising and lowering a back and leg rest and also raising and lowering the bed as a whole. For this purpose the hand control is equipped with keys placed in pairs, where one key brings about the raising and the other one the lowering.

The hand control comprises a housing 1 wherein a printed circuit with tactile switches 2 is mounted, and above is a plate with tongue like keys 3, which in their basic form are a circular brick 4 at the end of a stalk 5. The top side of the housing is equipped with a cover foil 9 with graphics 3′ localizing the keys and their function.

As can be seen from the detailed view in FIG. 4 the keys 3 are shaped with a spring leg 6. By pressing the key the spring leg will immediately press the activation element 7 of the tactile switches and thereby create electric contact. Continued pressing on the button will cause a continued migration, after migration in the spring leg. Even though the user relieves the pressure on the key, the switch will still be active. It is understood that the elasticity in the spring leg is adjusted so that the user has an after migration on the key at the same time as there is a unique activation of the switch.

Another embodiment of the invention is suggested in FIG. 5, where the keys in contradistinction to the above design are equipped with a springy rubber layer 8 on the underside. This rubber layer can be a rubber brick, mounted on the underside of the key 3, or the rubber can be molded integral with the key.

FIG. 6 of the drawing shows a curve illustrating the sequence of pressing the keys, where the x-axis shows the migration of the key and the y-axis the applied pressing force. Starting off with a press of the maximum force where the tactile switch is activated and in the following movement the press falls. Other things being equal, the user experiences it as a “good” press on the keys with a unique activation of the key and a soft holding pressure.

1. Electric hand control comprising; a housing (1), a printed circuit with an electric circuit and a number of switches with an axially movable activation element which can migrate between a starting position and an end position, a plate located above the printed circuit and with a number of herein detached bricks elastically connected to the remaining parts of the plate as control keys for activating the switches, a foil mounted over the plate with markings for the control keys, wherein a spring element is located between the control keys and the activation element of the switches so that an after migration of the control key is obtained after the activation element of the switches has reached its end position.

2. Hand control according to claim 1, wherein the switches are tactile switches.

3. Hand control according to claim 1, wherein the spring element is a spring leg in a plastic cover plate.

4. Hand control according to claim 1, wherein the spring element is a rubber element moulded integral with the control key.
